(19) United States
(12) Patent Application Publication
(10) Pub. No.: US 2023/0107810 A1
(43) Pub. Date: Apr. 6, 2023

(54) BALL SCREW ROTARY ACTUATOR WITH INDEPENDENT BALL PATHS

(71) Applicant: The Boeing Company, Chicago, IL (US)

(72) Inventor: Mitchell Loren Ray Mellor, Bothell, WA (US)

(21) Appl. No.: 17/491,699

(22) Filed: Oct. 1, 2021

(51) Int. Cl. F16H 25/22; F16H 25/20; F15B 15/06; B64C 13/36

(52) U.S. Cl. CPC F16H 25/2214; F16H 25/2018; F15B 15/068; B64C 13/36

(57) ABSTRACT

Ball screw rotary actuator with independent ball paths. In one embodiment, a ball screw rotary actuator includes an outer cylinder including a fluid port, a piston configured to translate within the outer cylinder due to fluid pressure, helical grooves disposed between the outer cylinder and the piston, and outer ball bearings configured to travel in the helical grooves to rotate the piston within the outer cylinder as the piston translates. The ball screw rotary actuator also includes an inner shaft situated radially inward of the piston, straight grooves disposed between the piston and the inner shaft, and inner ball bearings configured to travel in the straight grooves, and to rotate the inner shaft as the piston rotates.

### FIELD

This disclosure relates to the field of actuators, and in particular, to rotary actuators.

### BACKGROUND

A rotary actuator is a mechanical device that creates rotary motion. A screw rotary actuator is one type of actuator that is commonly used in heavy machinery. A screw rotary actuator is a mechanical device that turns linear motion into rotary motion. Although considered reliable and robust for industrial uses, screw rotary actuators are heavy, have high friction, and cannot be back-driven, making them unsuitable for aerospace applications.

A ball screw is typically implemented as a type of linear actuator that translates rotational motion to linear force with little friction. A typical design of a ball screw actuator uses a low screw pitch (e.g., 4 to 20 threads per inch) so that the rod can be rotated at relatively low input torque to create relatively high linear force. However, while a ball screw is a commonly encountered type of linear actuator, it typically cannot be used as a rotary actuator which uses linear force to create rotary motion.

### SUMMARY

Embodiments herein describe a ball screw rotary actuator with independent ball paths. The independent ball paths circulate the ball bearings inside the actuator, eliminating external ball return tracks to simplify the design, and reduce the overall size of the actuator. Additionally, the ball bearings reduce internal friction and can be used in conjunction with a high screw pitch or lead to prevent the actuator from seizing in the event of failure. The rotary actuator is thus suitable for numerous applications in which size, weight, efficiency, and back-drive capability are of concern. As an example, the ball screw rotary actuator may be used to drive ailerons, flaps, and spoilers on thin wing airplane designs, and may be mounted directly on the hinge line or adjacent to it and not stick out from the wing contour.

One embodiment is a ball screw rotary actuator that includes an outer cylinder including a fluid port, a piston configured to translate within the outer cylinder due to fluid pressure, helical grooves disposed between the outer cylinder and the piston, and outer ball bearings configured to travel in the helical grooves to rotate the piston within the outer cylinder as the piston translates. The ball screw rotary actuator also includes an inner shaft situated radially inward of the piston, straight grooves disposed between the piston and the inner shaft, and inner ball bearings configured to travel in the straight grooves, and to rotate the inner shaft as the piston rotates.

Another embodiment is a method of assembling a ball screw rotary actuator. The method includes providing a piston to translate within an outer cylinder due to fluid pressure, forming helical grooves around an outer diameter of the piston, providing an inner shaft radially inward of the piston, and forming straight grooves between the inner shaft and the piston. The method also includes inserting outer ball bearings into the helical grooves to force rotation of the piston with respect to the outer cylinder as the piston translates due to the fluid pressure, and inserting inner ball bearings into the straight grooves to force rotation of the inner shaft with the rotation of the piston.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments are now described, by way of example only, and with reference to the accompanying drawings. The same reference number represents the same element or the same type of element on all drawings.

FIG. 1 is a cutaway perspective view of a ball screw rotary actuator in an illustrative embodiment.

FIG. 2 is a partial cross-sectional side view of the ball screw rotary actuator in an illustrative embodiment.

FIG. 3 is a cutaway perspective view of the ball screw rotary actuator in another illustrative embodiment.

FIG. 4 is a cutaway perspective view of the ball screw rotary actuator in yet another illustrative embodiment.

FIG. 5 is a cross-sectional view of the ball screw rotary actuator in an illustrative embodiment.

FIG. 6 is a perspective view of a piston 600 in an illustrative embodiment.

FIG. 7 is a flowchart of a method of assembling a ball screw rotary actuator in an illustrative embodiment.

FIG. 8A is a side view of a wing including a control surface rotatable via the ball screw rotary actuator in an illustrative embodiment.

FIG. 8B is a side view of a multi-element wing including a first control surface and second control surface rotatable via ball screw rotary actuators in another illustrative embodiment.

FIG. 9 is a block diagram of an aircraft including the ball screw rotary actuator in an illustrative embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure are to be construed as being without limitation. As a result, this disclosure is not limited to the specific embodiments or examples described below, but by the claims and their equivalents.

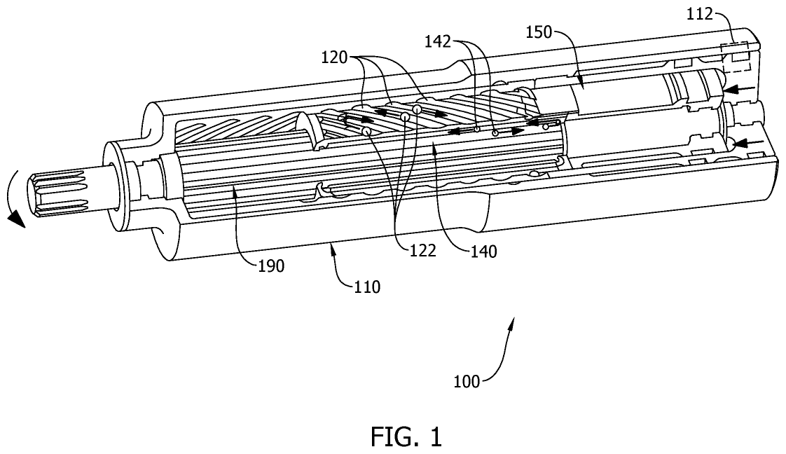

FIG. 1 is a cutaway perspective view of a ball screw rotary actuator 100 in an illustrative embodiment. The ball screw rotary actuator 100 includes an outer cylinder 110, a piston 150, and an inner shaft 190. The outer cylinder 110 includes one or more fluid ports 112 to admit a hydraulic fluid from a hydraulic fluid source. Differential fluid pressure drives the piston 150 left or right. For example, FIG. 1 shows leftward arrows indicating a linear force acting upon the piston 150. The piston 150 is thus configured to translate within the outer cylinder 110 due to fluid pressure. The inner shaft 190 is situated radially inward from the piston 150, and one or both ends of the inner shaft 190 may protrude from the outer cylinder 110. The outer cylinder 110, piston 150, and inner shaft 190 may thus be coaxially arranged about a common longitudinal axis.

The ball screw rotary actuator 100 also includes helical grooves 120 disposed between the outer cylinder 110 and the piston 150. Outer ball bearings 122 travel in the helical grooves 120 to rotate the piston 150 within the outer cylinder 110 as the piston 150 translates. Advantageously, the helical grooves 120 form a ball screw in which the outer ball bearings 122 recirculate as shown by the ball traveling arrows of FIG. 1. The ball screw rotary actuator 100 further includes straight grooves 140 disposed between the piston 150 and the inner shaft 190. Inner ball bearings 142 travel in the straight grooves 140 and rotate the inner shaft 190 (as shown by rotation arrow in FIG. 1) as the piston 150 rotates. In other words, the inner ball bearings 142 minimize friction in the axial or longitudinal direction, and key the piston 150 to the inner shaft 190 so that the piston 150 and inner shaft 190 rotate together. Accordingly, the ball screw rotary actuator 100 translates linear force into rotary motion.

Compared with traditional screw rotary actuators that provide approximately forty to sixty percent efficiency, the ball screw rotary actuator 100, through the use of ball bearings 122/142 that roll with minimal friction, provides greater than ninety-five percent efficiency. The ball screw rotary actuator 100 is also lightweight and configured to be back-driven, making it suitable for various aerospace applications such as flight control surfaces. Additionally, the ball bearings 122/142 recirculate in respective, independent grooves 120/140, eliminating external ball return tracks to reduce overall size. For ease of illustration, the drawings depict a few representative ball bearings 122/142, though it will be appreciated that actual implementations may pack the grooves 120/140 with dozens or hundreds of ball bearings 122/142 immersed in a hydraulic fluid for lubrication.

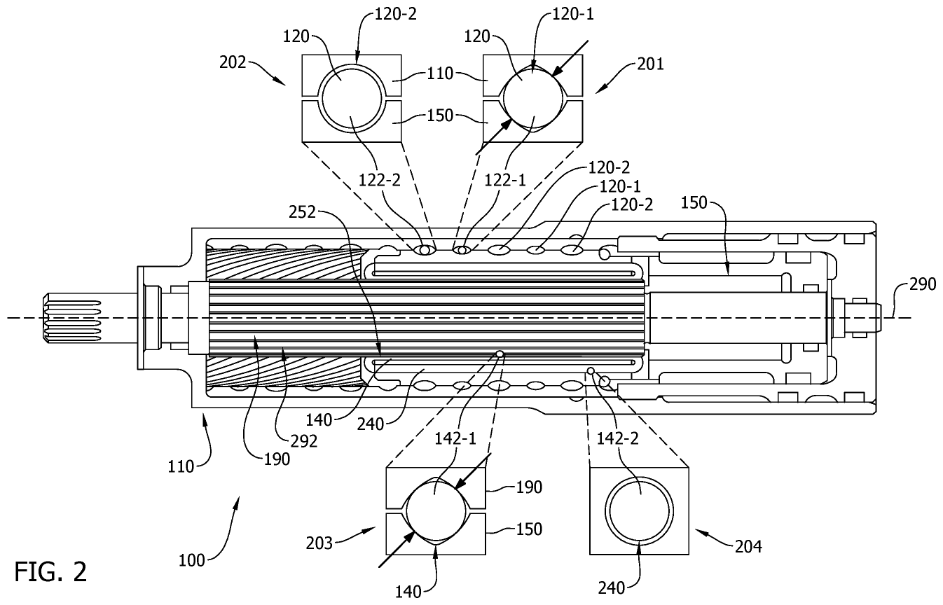

FIG. 2 is a partial cross-sectional side view of the ball screw rotary actuator 100 in an illustrative embodiment. FIG. 2 illustrates ball recirculation in/around the piston 150 using loaded and unloaded paths. In particular, the helical grooves 120 include loaded paths 120-1 and unloaded paths 120-2 that alternate with one another in the axial direction (i.e., longitudinal direction or direction parallel with an axis 290 of the inner shaft 190) of the ball screw rotary actuator 100. The loaded paths 120-1 are sized with a diameter slightly smaller than that of the outer ball bearings 122 such that the outer ball bearings 122 contact the inner walls of the loaded path 120-1 and actively carry load. Exploded view 201 illustrates a loaded ball bearing 122-1 travelling in a loaded path 120-1 with arrows indicating opposing contact forces of the outer cylinder 110 and piston 150 acting upon the loaded ball bearing 122-1. The loaded paths 120-1 and loaded ball bearings 122-1 thus force the piston 150 to rotate with respect to the outer cylinder 110 due to the twisting path shape and fit of the outer ball bearings 122 in the loaded paths 120-1.

By contrast, the unloaded paths 120-2 are sized such that the outer ball bearings 122 have clearance from the inner walls of the unloaded path 120-2. Exploded view 202 illustrates an unloaded ball bearing 122-2 travelling in an unloaded path 120-2 with clearance. That is, each unloaded path 120-2 is sized with a diameter larger than that of the outer ball bearings 122 such that the outer ball bearings 122 cannot take load or bind as they return to the loaded paths 120-1. Accordingly, the outer ball bearings 122 circulate in a helical motion around the piston 150, alternating between a loaded path 120-1 and unloaded path 120-2.

FIG. 2 also illustrates the piston 150 includes an inner diameter configured to circulate inner ball bearings 142 along straight grooves 140. In particular, the inner diameter of the piston 150 forms straight grooves 140 and inner ball return paths 240. The straight grooves 140 are formed by the interface of an innermost diameter 252 of the piston 150 and roller gear teeth 292 of the inner shaft 190. Exploded view 203 illustrates a loaded inner ball bearing 142-1 travelling in a straight groove 140 with arrows indicating opposing contact forces of the piston 150 and the inner shaft 190 acting upon the loaded inner ball bearing 142-1. The straight grooves 140 are thus sized with a diameter slightly smaller than that of the inner ball bearings 142 such that the inner ball bearings 142 contact the inner walls of the straight groove 140. The straight groove 140 and loaded inner ball bearing 142-1 thus force the inner shaft 190 to rotate with the piston 150.

An inner ball return path 240 pairs with each straight groove 140 to circulate the inner ball bearings 142 in a lengthwise direction (i.e., axial or longitudinal direction) of the piston 150. The inner ball return paths 240 may be disposed radially outward from the straight grooves 140 as shown in FIG. 2. Each inner ball return path 240 may comprise an inner hollow area of the piston 150 sized with a diameter larger than that of the inner ball bearings 142 such that the inner ball bearings 142 cannot take load or bind as they return to the straight groove 140. Exploded view 204 illustrates an unloaded inner ball bearing 142-2 travelling in an inner ball return path 240 with clearance. Accordingly, the inner ball bearings 142 may circulate in a closed loop comprising a straight groove 140 and corresponding inner ball return path 240. Moreover, the inner ball bearings 142 and outer ball bearings 122 travel in independent ball paths. The ball screw rotary actuator 100 thus includes a configuration of loaded and unloaded ball paths that enable rotary actuation with minimal friction. Additionally, inner/outer ball paths of the piston 150 circulate balls independently to eliminate external ball paths and reduce overall size of the ball screw rotary actuator 100.

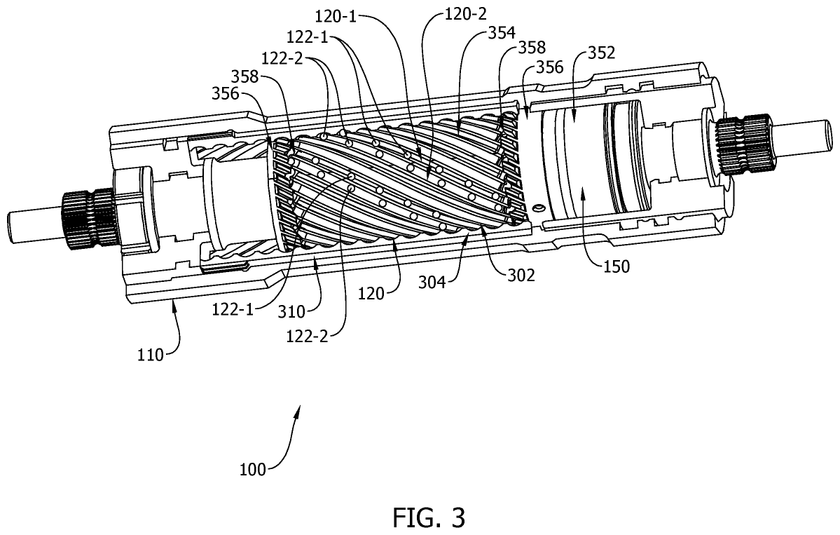

FIG. 3 is a cutaway perspective view of the ball screw rotary actuator 100 in another illustrative embodiment. FIG. 3 more clearly shows an outer diameter 302 of the piston 150. The piston 150 includes one or more end portions 352 and a threaded rod portion 354. At each end of the threaded rod portion 354, the piston 150 includes end caps 356. Each end cap 356 includes outer turn channels 358 configured to recirculate the outer ball bearings 122 in the helical grooves 120. Accordingly, the outer ball bearings 122 circulate in the helical grooves 120 of the outer diameter 302 of the piston 150. As previously described, the outer ball bearings 122 alternate between a loaded path 120-1 and unloaded path 120-2. As an outer ball bearing 122 is turned by a turn channel 358, it changes from a loaded ball bearing 122-1 to an unloaded ball bearing 122-2 or vice versa.

The outer diameter 302 of the piston 150 faces an inner diameter 304 of the outer cylinder 110 to form the helical grooves 120. In particular, the inner diameter 304 of the outer cylinder 110 may include a helical sleeve 310 situated inside the outer cylinder 110 to form its inner walls. Accordingly, the outer ball bearings 122 may be disposed between the piston 150 and the helical sleeve 310. The outer diameter 302 of the piston 150 includes the male portion of a ball screw (i.e., male portion or threads of the helical grooves 120). And, the inner diameter 304 of the helical sleeve 310 (or outer cylinder 110) includes the female portion of the ball screw (i.e., female portion or threads of the helical grooves 120). The helical sleeve 310 may be disposed inside the pressure vessel formed by the outer cylinder 110 such that it does not react pressure loads, and the helical ball screw track may thus advantageously avoid deflection due to pressure.

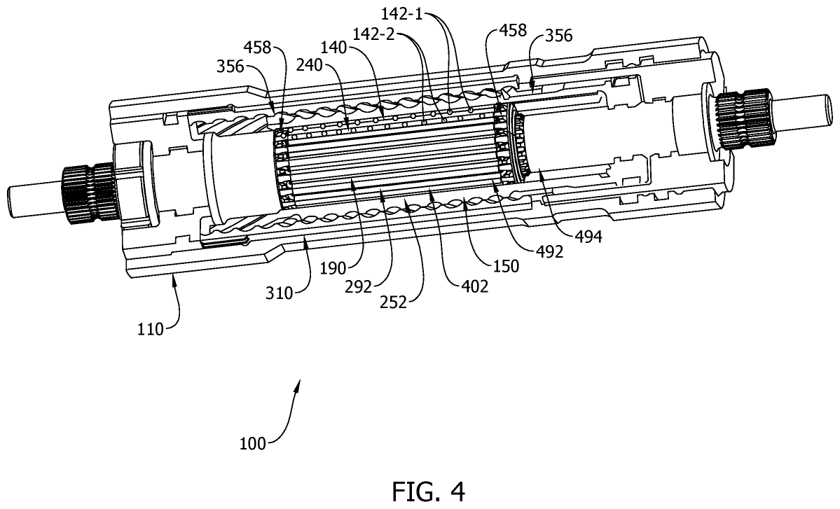

FIG. 4 is a cutaway perspective view of the ball screw rotary actuator 100 in yet another illustrative embodiment. FIG. 4 more clearly shows an outer diameter 402 of the inner shaft 190. In particular, the inner shaft 190 may include a shaft sleeve 492 slid over a shaft 494 and coupled for co-rotation. The end caps 356 includes inner turn channels 458 configured to recirculate the inner ball bearings 142 in the straight grooves 140 formed on the outer diameter 402 of the shaft sleeve 492. The inner ball bearings 142 thus circulate or alternate between a straight groove 140 and an inner ball return path 240. In other words, the inner ball bearings 142 change from loaded inner ball bearings 142-1 (which travel in an active groove to key the piston 150 and the inner shaft 190 together for co-rotation) to unloaded inner ball bearings 142-2 (which travel in an inactive groove with clearance in the return path) and vice versa. An innermost diameter 252 of the piston 150 includes a female portion of the straight grooves 140 (or roller gear teeth 292). And, the outer diameter 402 of the inner shaft 190 includes a male portion of the straight grooves 140 (or roller gear teeth 292). The outer diameter 402 of the inner shaft 190 and the innermost diameter 252 of the piston 150 interface to form the straight grooves 140 spaced from one another around a circumference of the inner shaft 190.

In one embodiment, the ball screw rotary actuator 100 uses a large screw pitch (e.g., ten or more inches of stroke per rotation) so that the ball screw rotary actuator 100 can be back-driven by applying torque to the inner shaft 190. This prevents the ball screw rotary actuator 100 from seizing in the event of a power failure. Additionally, a relatively high output torque may be achieved with a relatively low linear input force. By contrast, traditional ball screw designs intended for linear actuation use a low screw pitch to create a greater linear force with low input torque. The large screw pitch also allows multiple thread starts to be oriented around the piston 150, outer cylinder 110, and inner shaft 190. More thread starts allow more ball bearings to carry the contact loads between the components. In the example shown, there are twelve thread starts on the ball nut formed by the piston 150 and the helical sleeve 310, and twelve ball tracks (e.g., straight grooves 140) on the inner shaft 190. However, any number of thread starts could be used based on the size of the actuator and size of ball bearings chosen.

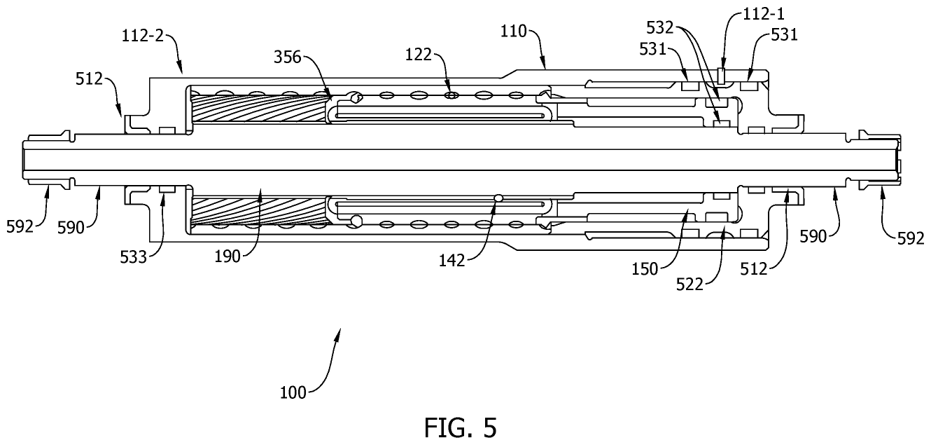

FIG. 5 is a cross-sectional view of the ball screw rotary actuator 100 in an illustrative embodiment. FIG. 5 more clearly illustrates various other components of the ball screw rotary actuator 100 not yet described. For example, the inner shaft 190 may include splines 590 to transmit torque to a desired mechanical element such as spoiler fittings. The inner shaft 190 may also include journals 592 to mount with bearings of external structure. One or both distal ends of the inner shaft 190, including splines 590 and/or journals 592, may protrude from the outer cylinder 110 depending on whether single or dual output is desired. The example of FIG. 5 shows a dual output configuration with a right fluid port 112-1 and left fluid port 112-2 for fluid input.

Additionally, the inner shaft 190 may be supported within the outer cylinder 110 via bushings 512 at one or both ends of the outer cylinder 110. An adjustable end gland 522 surrounding the piston head at one end of the outer cylinder 110 enables, for example, spoiler rigging on a wing of an aircraft. Seals 531-533 maintain pressure load within the ball screw rotary actuator 100. For example, static seals 531 may be disposed between the adjustable end gland 522 and outer cylinder 110. Dynamic seals 532 may be disposed between the adjustable end gland 522 and piston 150, and between the piston 150 and inner shaft 190. And, rotary seals 533 may be disposed between the inner shaft 190 and outer cylinder 110.

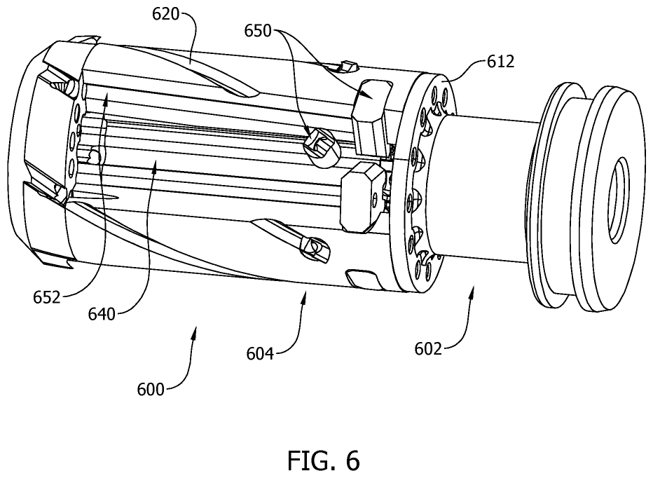

FIG. 6 is a perspective view of a piston 600 in an illustrative embodiment. The piston 600 includes features and elements which may be additionally or alternatively implemented in the ball screw rotary actuator 100. For example, the piston 600 may include a piston head 602 and a ball nut 604 that are detachable from each other via bolts 612 to facilitate ball installation. Additionally, in this example, ball return guides 650 move ball bearings (not shown) from loaded outer tracks 620 and loaded inner tracks 640 to ball tubes 652. That is, the loaded outer tracks 620 form helical grooves around the outer diameter of the piston 600, and the loaded inner tracks 640 form straight grooves along the inner diameter of the piston 600, providing features and functions previously described. However, in this example, the unloaded ball return paths are disposed radially between the outer diameter and inner diameter of the piston 600. That is, the ball tubes 652 belonging to the loaded outer tracks 620 may share a common radius with the ball tubes 652 belonging to the loaded inner tracks 640.

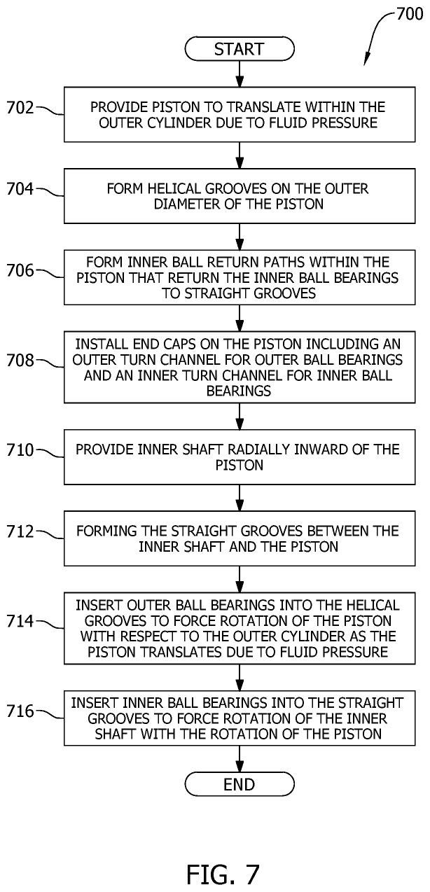

FIG. 7 is a flowchart of a method 700 of assembling a ball screw rotary actuator in an illustrative embodiment. The steps of the method 700 will be described with reference to the ball screw rotary actuator 100 of FIGS. 1-5, but those skilled in the art will appreciate that the method 700 may be performed in alternative rotary actuators. The steps of the flowchart(s) described herein are not all inclusive and may include other steps not shown. The steps described herein may also be performed in an alternative order.

In step 702, the piston 150 is provided to translate within the outer cylinder 110 due to fluid pressure. In step 704, helical grooves 120 are formed on the outer diameter 302 of the piston 150. In step 706, inner ball return paths 240 are formed within the piston that return the inner ball bearings to the straight grooves. In step 708, end caps 356 are installed on the piston 150 which include an outer turn channel 358 to recirculate the outer ball bearings 122 in the helical grooves 120, and an inner turn channel 458 to recirculate the inner ball bearings 142 in the straight grooves 140.

In step 710, the inner shaft 190 is provided radially inward of the piston 150. In step 712, straight grooves 140 are formed between the inner shaft 190 and the piston 150. In step 714, outer ball bearings 122 are inserted into the helical grooves 120 to force rotation of the piston 150 with respect to the outer cylinder 110 as the piston 150 translates due to the fluid pressure. And, in step 716, inner ball bearings 142 are inserted into the straight grooves 140 to force rotation of the inner shaft 190 with the rotation of the piston 150. Advantageously, the method 700 forms the ball screw rotary actuator 100 providing numerous technical advantages in terms of size, weight, efficiency, and back-drive capability.

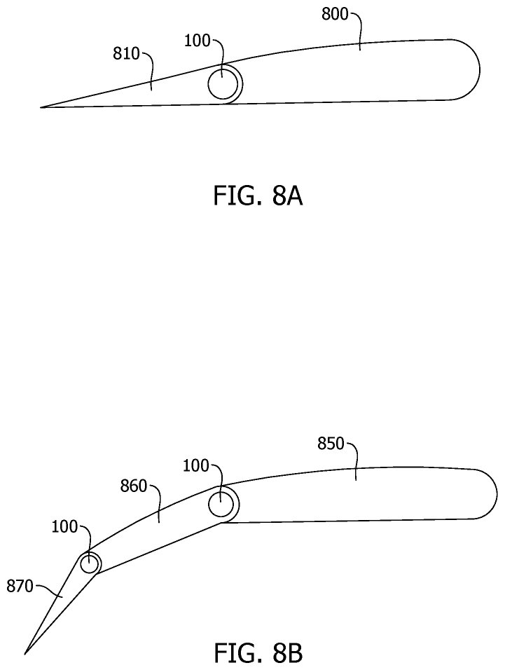

FIG. 8A is a side view of a wing 800 including a control surface 810 rotatable via the ball screw rotary actuator 100 in an illustrative embodiment. The control surface 810 may include, for example, a flap, aileron, or spoiler. FIG. 8B is a side view of a multi-element wing 850 including a first control surface 860 and second control surface 870 rotatable via ball screw rotary actuators 100 in another illustrative embodiment. The small profile of the ball screw rotary actuators 100 may advantageously be incorporated into thin wing designs or implemented on multi-element flap systems to eliminate traditional canoe fairings.

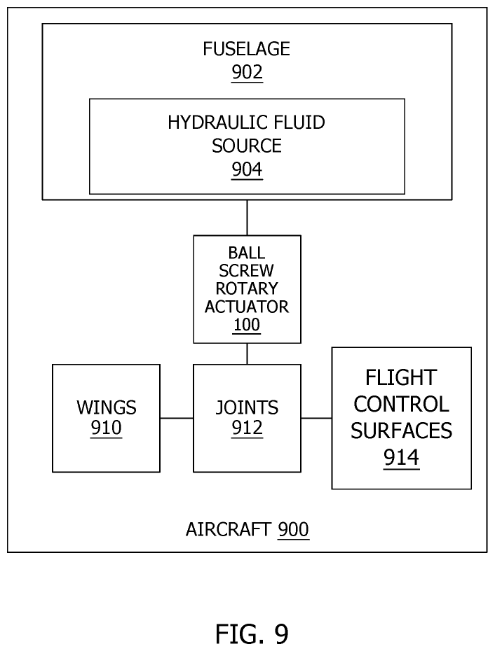

FIG. 9 is a block diagram of an aircraft 900 including the ball screw rotary actuator 100 in an illustrative embodiment. The aircraft 900 includes a fuselage 902 and one or more wings 910 projecting from the fuselage 902. The wings 910 are connected to flight control surfaces 914 via joints 912. The ball screw rotary actuator 100 is connected to the joint and configured to rotate the flight control surface 914 with respect to the wing 910. A hydraulic fluid source 904 of the aircraft 900 supplies fluid to the ball screw rotary actuator 100 to move the flight control surfaces 914.

Although specific embodiments were described herein, the scope is not limited to those specific embodiments. Rather, the scope is defined by the following claims and any equivalents thereof.

What is claimed is:

1. A ball screw rotary actuator, comprising:
an outer cylinder including a fluid port;
a piston configured to translate within the outer cylinder due to fluid pressure;
helical grooves disposed between the outer cylinder and the piston;
outer ball bearings configured to travel in the helical grooves to rotate the piston within the outer cylinder as the piston translates;
an inner shaft situated radially inward of the piston;
straight grooves disposed between the piston and the inner shaft; and
inner ball bearings configured to travel in the straight grooves, and to rotate the inner shaft as the piston rotates.

2. The ball screw rotary actuator of claim 1, wherein:
the outer ball bearings travel in the helical grooves independently from the inner ball bearings that travel in the straight grooves.

3. The ball screw rotary actuator of claim 1, wherein:
the piston includes a male portion of the helical grooves and a female portion of the straight grooves,
the outer cylinder includes a female portion of the helical grooves, and
the inner shaft includes a male portion of the straight grooves.

4. The ball screw rotary actuator of claim 1, wherein:
the piston includes an end cap with an outer turn channel to recirculate the outer ball bearings in the helical grooves, and an inner turn channel to recirculate the inner ball bearings in the straight grooves.

5. The ball screw rotary actuator of claim 1, wherein:
the helical grooves include loaded paths sized smaller than the outer ball bearings, and unloaded paths sized larger than the outer ball bearings.

6. The ball screw rotary actuator of claim 5, wherein:
the loaded paths and the unloaded paths alternate in an axial direction of the ball screw rotary actuator.

7. The ball screw rotary actuator of claim 5, wherein:
in the loaded paths, the outer ball bearings are pressed by opposing forces of the piston and the outer cylinder and force the piston to rotate with respect to the outer cylinder as the outer ball bearings travel in the helical grooves, and
in the unloaded paths, the outer ball bearings have clearance to avoid binding as the outer balls return to the loaded paths.

8. The ball screw rotary actuator of claim 1, wherein:
the piston includes inner ball return paths configured to return the inner ball bearings to the straight grooves.

9. The ball screw rotary actuator of claim 1, wherein:
the straight grooves are parallel with an axis of the inner shaft.

10. A method of assembling a ball screw rotary actuator, the method comprising:
providing a piston to translate within an outer cylinder due to fluid pressure;
forming helical grooves around an outer diameter of the piston;
providing an inner shaft radially inward of the piston;
forming straight grooves between the inner shaft and the piston;
inserting outer ball bearings into the helical grooves to force rotation of the piston with respect to the outer cylinder as the piston translates due to the fluid pressure; and
inserting inner ball bearings into the straight grooves to force rotation of the inner shaft with the rotation of the piston.

11. The method of claim 10, wherein:
the outer ball bearings travel in the helical grooves independently from the inner ball bearings that travel in the straight grooves.

12. The method of claim 10, wherein:
installing end caps on the piston which include an outer turn channel to recirculate the outer ball bearings in the helical grooves, and an inner turn channel to recirculate the inner ball bearings in the straight grooves.

13. The method of claim 10, further comprising:
forming inner ball return paths within the piston that return the inner ball bearings to the straight grooves.

14. The method of claim 10, wherein:
the straight grooves are parallel with an axis of the inner shaft.

15. An aircraft, comprising:
a fuselage;
a wing projecting from the fuselage;
a flight control surface connected to the wing via a joint; and
a ball screw rotary actuator connected to the joint and configured to rotate the flight control surface with respect to the wing, the ball screw rotary actuator comprising:
an outer cylinder including a fluid port;
a piston configured to translate within the outer cylinder due to fluid pressure;
helical grooves disposed between the outer cylinder and the piston;
outer ball bearings configured to travel in the helical grooves to rotate the piston within the outer cylinder as the piston translates;
an inner shaft situated radially inward of the piston;
straight grooves disposed between the piston and the inner shaft; and
inner ball bearings configured to travel in the straight grooves, and to rotate the inner shaft as the piston rotates.

16. The aircraft of claim 15, wherein:
the helical grooves include a screw pitch to rotate the inner shaft one revolution for at least ten inches of translation of the piston.

17. The aircraft of claim 16, wherein:
the screw pitch of the helical grooves enable the ball screw rotary actuator to be back-driven.

18. The aircraft of claim 15, wherein:
the outer ball bearings travel in the helical grooves independently from the inner ball bearings that travel in the straight grooves.

19. The aircraft of claim 15, wherein:
the piston includes inner ball return paths configured to return the inner ball bearings to the straight grooves.

20. The aircraft of claim 15, wherein:
the straight grooves are parallel with an axis of the inner shaft.
